(19) United States
(12) Patent Application Publication
(10) Pub. No.: US 2015/0302493 A1
(43) Pub. Date: Oct. 22, 2015

(54) INTERACTIVE TRANSACTIONS

(71) Applicant: LuvTap, San Francisco, CA (US)

(72) Inventors: David Bruce Batstone, El Granada, CA (US); Gabriel Adam Brown, Pacifica, CA (US)

(21) Appl. No.: 14/687,798

(22) Filed: Apr. 15, 2015

Related U.S. Application Data
(60) Provisional application No. 61/980,436, filed on Apr. 16, 2014.

(51) Int. Cl. G06Q 30/06; H04W 4/12

(52) U.S. Cl. CPC G06Q 30/0601; H04W 4/12

(57) ABSTRACT

A method may include receiving, by a processing device of a server, a selected voucher from a plurality of vouchers, a name and phone number of a recipient, an identifier message, and payment information from a first user device. The method may also include sending to a second user device an anonymous message containing a unique link to the voucher and receiving a notification that the recipient clicked the unique link to the voucher. After receiving notification that the unique link has been activated on the second user device, the method may also include sending a verification code and an identifier message to the second user device. The method may also include receiving a second notification that the second user device redeemed the voucher.

### REFERENCE TO RELATED APPLICATION

This application claims the benefit of U.S. Provisional Application No. 61/980,436, filed Apr. 16, 2014 which is hereby incorporated by reference in its entirety.

### TECHNICAL FIELD

This disclosure relates to the field of interactive transactions and, in particular, to anonymous gifting interactive transactions.

### BACKGROUND

Gift giving has long been a great way to show someone that you are appreciative of them, thinking about them, and care about them. Traditionally, gifts have been all shapes and sizes, small and large, inexpensive and expensive, impersonal to sentimental. Even small, inexpensive gifts mean a lot to recipients, and are typically given by those wanting to show appreciation or thoughtfulness.

Giving gifts can sometimes require more work than a prospective benefactor is willing to perform. Especially when giving a small gift, the thought of driving to the store, picking out a small item, and driving it over to someone's house may dissuade someone who is otherwise able and willing to give a gift. Additionally, someone looking to pick out a small, thoughtful gift often encounters a problem when trying to decide what gift to purchase. Going to a store produces a limited selection, from which available gifts may not adequately express the feelings the benefactor desires to convey.

This problem is made worse when the benefactor and intended recipient do not live in close proximity to each other. The benefactor is forced to choose between sending a gift card for a retailer that he or she knows is available in the area in which the recipient lives, or buying a gift locally and having it shipped. The former can be less thoughtful than the benefactor intends and the latter can be somewhat cumbersome.

While the act of giving a thoughtful gift certainly makes the benefactor feel good, the act is typically carried out for the sole purpose of making the recipient happy. With this objective in mind, many benefactors wish to remain temporarily or permanently anonymous. Temporary anonymity creates mystery and suspense in the eyes of the recipient and can enhance the overall experience of both giving and receiving a gift. When a recipient does eventually determine who their benefactor is, they get to relive the same feelings of excitement they had when they initially received the gift.

### BRIEF DESCRIPTION OF THE DRAWINGS

The present disclosure will be understood more fully from the detailed description given below and from the accompanying drawings of various embodiments of the present disclosure, which, however, should not be taken to limit the present disclosure to the specific embodiments, but are for explanation and understanding only.

FIG. 1 is a block diagram illustrating an exemplary network architecture in which embodiments of the present disclosure may be implemented.

FIG. 2 is a flow diagram illustrating a benefactor-side interactive transaction processing flow, according to an implementation.

FIG. 3A is a flow diagram illustrating the first part of a recipient-side interactive transaction processing flow, according to an implementation.

FIG. 3B is a flow diagram illustrating the second part of a recipient-side interactive transaction processing flow, according to an implementation.

FIG. 4 is a flow diagram illustrating an interactive transaction application download processing flow, according to an implementation.

FIG. 5A is a block diagram illustrating a tutorial screen of an interactive transaction application, according to an implementation.

FIG. 5B is a block diagram illustrating a gift detail screen of an interactive transaction application, according to an implementation.

FIG. 6A is a block diagram illustrating a location view screen of an interactive transaction application, according to an implementation.

FIG. 6B is a block diagram illustrating a send gift screen of an interactive transaction application, according to an implementation.

FIG. 7A is a block diagram illustrating a hint message screen of an interactive transaction application, according to an implementation.

FIG. 7B is a block diagram illustrating a hint message dropdown screen of an interactive transaction application, according to an implementation.

FIG. 8A is a block diagram illustrating a send gift screen of an interactive transaction application, according to an implementation, according to an implementation.

FIG. 8B is a block diagram illustrating a gift history screen of an interactive transaction application, according to an implementation.

FIG. 9A is a block diagram illustrating an anonymous message, according to an implementation.

FIG. 9B is a block diagram illustrating an identifier message, according to an implementation.

FIG. 10 is a block diagram of a service device in the example form of a computing device, according to an implementation.

### DETAILED DESCRIPTION

Embodiments are described for interactive transactions. The methods described in the present disclosure allow for an individual to purchase a gift via an online web service or mobile application and anonymously send it to a recipient. At the time of purchase, the benefactor may be allowed to compose a short character message that can be used to reveal his or her identity to the recipient. This identifier message may be released to the recipient upon redemption of the gift at a selected retailer. Benefactors may also be given the option to offer an identity “hint” to the recipient of the gift at the time the digital gift voucher is delivered.

In one embodiment, a benefactor may send a small gift of a coffee to a recipient. The benefactor first opens the application on a mobile device or the web and selects “coffee” from the list of available gift options. Following the gift purchase, a message sent via Short Message Service (SMS) may alert the recipient that they have received an interactive transactional gift. The message received by the person receiving the gift may read:
You have been gifted a cappuccino at Starbucks.
To receive your gift and discover the identity
of your giver visit http://luvtap.co/M0PqP.

The beneficiary have had a product (e.g., a cappuccino) pre-purchased for them from a participating retailer. To receive the gift the beneficiary will need to visit the store listed in the message. In one embodiment, only upon visiting store redeeming the gift will the beneficiary learn the identity of the giver. Unlocking the mystery of who the benefactor is provides additional excitement and enjoyment to the recipient. In another embodiment, the benefactor may choose to have a hint message displayed to the recipient when he or she receives the notification of their gift. For example, a message that includes a hint could read:
You have been gifted a cappuccino at Starbucks
by someone with whom you met last week.
To receive your gift and discover the identity
of your giver visit http://luvtap.co/M0PqP.

The cost of the gift may be the retail price of the gift plus some nominal fee. In one embodiment, a portion of the nominal fee will go towards a charity of the benefactor's choice. In addition to a revenue share of every gift purchase going to charity, in one embodiment the benefactor may be prompted with an opportunity to make a make an additional charitable donation. In another embodiment, at Point of Sale (POS) the person receiving the gift will be given an opportunity to also make a donation to charity. Additionally, the benefactor may have the option to choose gifts from local retailers, in an effort to support local business.

While embodiments may be described in relation to certain types of messages, in alternative embodiments, the methods and apparatus discussed herein may also be used with other types of messages. For example, in alternative embodiments, the methods described herein could implement email messaging, chat client messaging, social media messaging, as well as any other type of messaging service.

This type of interactive transaction described herein allows an individual to avoid the sometimes costly and time-intensive processes having to go to the store to purchase a gift, then delivering the gift in person or sending it through the mail. It avoids the wait time associated with physically going to a store and the delivery time of sending the gift through the postal service. Since the interactive transactional gifts are stored on a person's mobile device, they are not as easily lost and are available whenever a person wants them. Additionally, because the sender of a gift is temporarily anonymous, the overall experience of the recipient is more exciting and memorable.

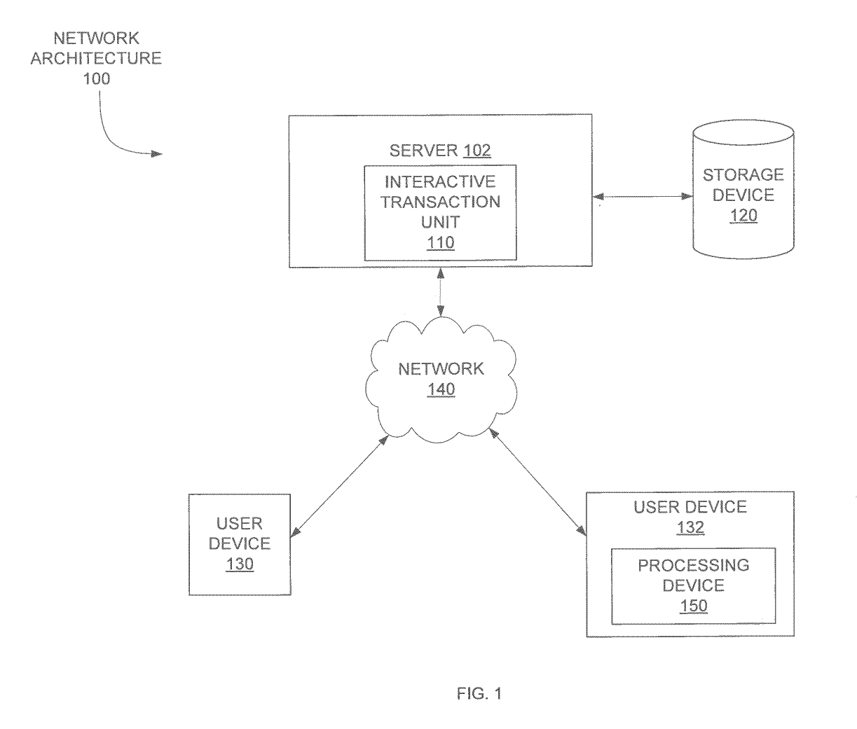

FIG. 1 is a block diagram illustrating an exemplary network architecture in which embodiments of the present disclosure may be implemented. The network architecture 100 may include one or more servers 102 communicating with one or more user devices 130, 132 over one or more networks 140, according to one embodiment. Network 140 can be a local area network (LAN), a wireless network, a telephone network, a mobile communications network, a wide area network (WAN), such as the Internet, or similar communication system. User devices 130, 132 may be any type of computing device including server computers, gateway computers, desktop computers, laptop computers, game consoles, mobile communications devices, cell phones, smart phones, hand-held computers, tablets, smart TVs, set-top boxes, or similar computing devices. The user devices 130, 132 may be variously configured with different features to enable viewing of visual content, such as images, videos, etc. User devices 130, 132 may include one or more processing devices 150.

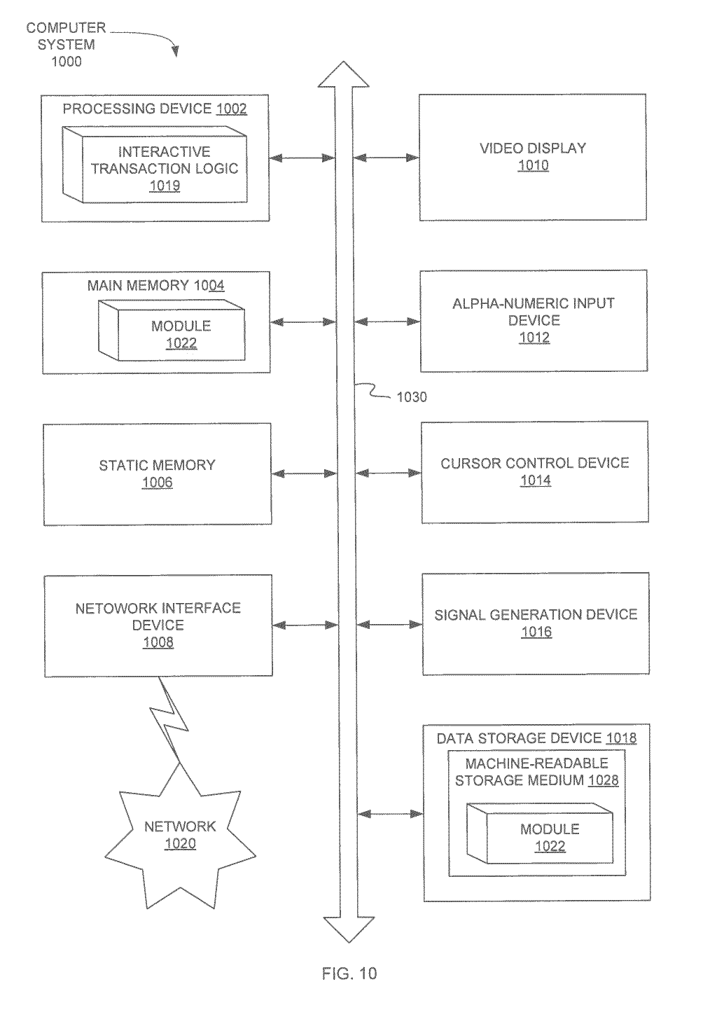

Server 102 may include a network-accessible server-based functionality, various data stores, and/or other data processing equipment. The server 102 may be implemented by a single machine or a cluster of machines. Server 102 may include, for example, computer system 1000 of FIG. 10. In one embodiment, server 102 includes interactive transaction unit 110. Interactive transaction unit 110 can receive a connection from a user device 130 and can also send data to user device 130. Upon connecting to a user device 130, the interactive transaction unit 110 can send and receive any type of information related to interactive transactions to and from user devices 130, 132 (e.g., of benefactors and recipients) connected to server 102. Server 102 may be one server or it may represent multiple servers. In one embodiment, when a first user connects a first user device 130 to server 102 and a second user connects a second user device 132 to server 102, server 102 may be the same server which handles both users' connections. In another embodiment, when a first user connects a first user device 130 to server 102 and a second user connects a second user device 132 to server 102, server 102 may represent different servers, so that each user connects to a different server.

In one embodiment, storage device 120 includes data store 222, in which may be stored phone numbers, email addresses gift details, payment details and all other types of interactive transaction related information. In response to a request from a user (e.g., received through one of user devices 130, 132), interactive transaction unit 110 can initiate an interactive transaction residing in data store 222. In another embodiment, a user, administrator, or interactive transaction unit may provide the functionality necessary to perform an interactive transaction that was not previously stored in storage device 120.

In one embodiment, server 102 may include interactive transaction unit 110 and storage device 120. In another embodiment, storage device 120 may be external to server 102 and may be connected to server 102 over a network or other connection. In other embodiments, server 102 may include different or additional components, or both, which are not shown here so as not to obscure the present disclosure. Storage device 120 may include one or more mass storage devices which can include, for example, flash memory, magnetic or optical disks, or tape drives, read-only memory (ROM); random-access memory (RAM); erasable programmable memory (e.g., EPROM and EEPROM); flash memory; or any other type of storage medium.

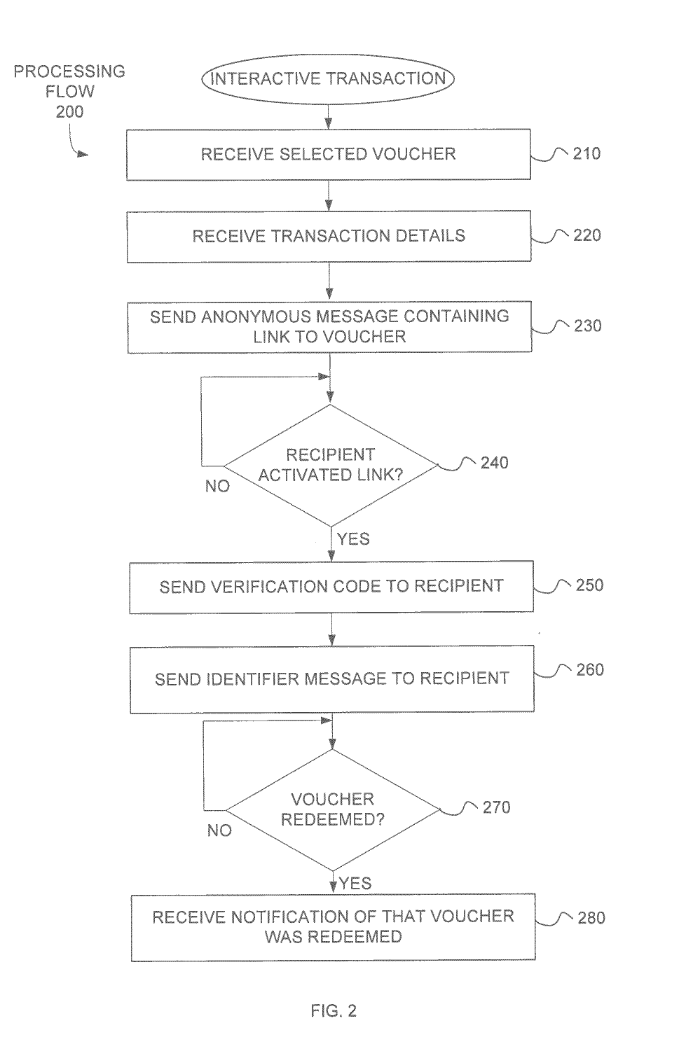

FIG. 2 is a flow diagram illustrating a benefactor-side interactive transaction processing flow, according to an implementation of the present disclosure. The processing flow method 200 may be performed by processing logic that includes hardware (e.g., circuitry, dedicated logic, programmable logic, microcode, etc.), software (e.g., instructions run on a processing device to perform hardware simulation), or a combination thereof. In one embodiment, interactive transaction unit 110 may perform method 200. Method 200 may be performed in any order so as to fit the needs of the specific interactive transaction to be performed.

Referring to FIG. 2, at block 210, method 200 receives a selected voucher from a benefactor's user device (e.g. user device 130). In one embodiment, vouchers may refer to general items such as “coffee,” “flowers,” “a candy bar,” and “a massage.” In one embodiment, vouchers may be associated with a particular genre of gift, and not a specific gift tied to a particular retailer. For example, if a benefactor would like to buy a coffee for a recipient and does not know from which coffee shop the recipient prefers her coffee, the benefactor may choose to simply gift a “coffee” and let the recipient choose where she would like to redeem the coffee voucher. In another embodiment, a benefactor may choose a specific item from a specific retailer as a gift. In this case, block 210 would receive a voucher from user device 130 that refers to a specific item instead of a category of items. In this embodiment, a voucher may, for example, be good for “a latte from Starbucks.” Depending one where the recipient is geographically located, different options for general and specific vouchers may be presented as choices to the benefactor. Additional details regarding methods of selecting vouchers as well as voucher options are discussed below.

At block 220, additional interactive transaction details may be received. In one embodiment, the recipient information is received. Recipient information may include, for example, one or more of a recipient's name, phone number, email address, social media handles, device Internet Protocol (IP) address, and mailing address. In other embodiments, other types of information may be received. In another embodiment, a benefactor's payment information may be received at this time. In one embodiment, payment information may include a credit card number and billing address. In another embodiment other types of payment information, such as PayPal™ credentials, may be received.

In one embodiment, an identifier message may also be received by processing logic at block 220. An identifier message may consist of a short message identifying the benefactor. In other embodiments, an identifier message may both identify the benefactor and explain why the gift was sent. For example, an identifier message may read, “Thank you for taking the time to meet with me last week” along with the name of the sender. In other embodiments, the benefactor may choose to remain anonymous and still send an identifier message. In this example, the identifier message may explain further why the gift was sent or simply contain words of encouragement or thoughtfulness.

In one embodiment, a hint message may be received at block 220. A hint message allows a benefactor to reveal just enough about who he or she is so that the recipient feels comfortable accepting the gift. More about hint messages will be discussed later in this disclosure. Other information that is related to the interactive transaction may also be received by processing logic at block 220.

At block 230, processing logic may send an anonymous message to the recipient's user device (e.g. user device 132) that contains a unique link to the voucher selected by the benefactor. In one embodiment, the unique link is generated by interactive transaction unit 110 on server 102. In one embodiment, all voucher information necessary to carry out an interactive transaction is associated with the unique link. Each voucher gets assigned a unique link that is valid only for the current voucher from the benefactor to the recipient. When a recipient activates the link on a user device 132, server 102 can determine based on the link, all relevant voucher information necessary to carry out an interactive transaction. In one embodiment, interactive transaction unit may generate a voucher code based on the unique link.

In one embodiment, the message is sent to the recipient via text message by utilizing a Short Message Service (SMS) gateway. In one embodiment, an SMS gateway allows the processing logic of method 200 to send and receive SMS transmissions to and from other devices. In another embodiment, the anonymous message may be sent via email. In other embodiments anonymous messages may be sent chat clients, social network applications and services, push notifications, and any other similar communication service.

In one embodiment, the anonymous message that contains a unique link to the selected voucher may include, for example, details about the voucher and instructions on how to redeem the voucher. For example, the message may state that a gift has been sent to the recipient, and the recipient should now click on the unique link in order to redeem the voucher. In one embodiment the gift details and the unique link to the voucher are sent in the same anonymous message. In another embodiment the gift details and the unique link to the voucher are sent in separate messages.

In one embodiment, a hint message may be sent in the anonymous message containing the gift details and unique link to the voucher. In another embodiment a hint message is sent in a separate message. In yet another embedment a hint message is not sent by the processing logic of method 200.

At block 240 the processing logic of method 200 waits for the recipient using a user device (e.g. user device 132) to activate the unique link sent in block 230. A user may activate a unique link contained in the message by clicking, holding down, or in some other way cause the user device 132 to follow the unique link. When the unique link is activated, flow continues to block 250.

At block 250, processing logic sends a verification code to the recipient's user device 132. In one embodiment, a verification code may consist of a short alphanumeric code. In one embodiment, a recipient must correctly enter the verification code in a text field of an interactive transaction application installed on the user device 132. In one embodiment, the verification code is used to verify that the person receiving the gift is the intended recipient. In one embodiment, after the verification code is correctly entered, processing logic may display the details of the gift on recipient's user device 132. In one embodiment, when a user is ready to redeem their gift, they may do so by activating a button on user device 132. Processing logic may then generate a voucher code and display it on user device 132. A vendor may then use the voucher code to redeem the voucher.

In one embodiment, when the recipient activates a button indicating a desire to redeem their gift, an expiration timer starts. In one embodiment, the expiration timer may reside on user device 132. In another embodiment, the expiration timer may reside on server 102. In a third embodiment, the expiration time may reside on both user device 132 and server 102. The expiration timer may determine the amount of time for which the voucher is good. Once the expiration timer expires for a particular voucher, the recipient may no longer be able to redeem the voucher. In one embodiment, when a voucher expires, the benefactor may receive a notification indicating the expiration. Upon receiving the notification, the benefactor may be presented with options to resend the gift. In one embodiment, the benefactor may only be able to resend the gift to the same recipient. In another embodiment, the benefactor may be able to send the gift to a different recipient.

In one embodiment, at block 260 the identifier message may be sent to the user device 132. The identifier message and any other voucher information necessary to complete an interactive transaction may be sent to user device 132 to be stored locally. After a voucher has been activated on user device 132 and voucher information including the identifier message have been sent to user device 132 for local storage, processing logic waits to receive a notification that the voucher has been redeemed at block 270. Once verification that the voucher has been redeemed is received flow continues to block 280. At block 280, processing logic receives a notification that the voucher has been redeemed. In one embodiment, the notification is sent to the benefactor's user device 130.

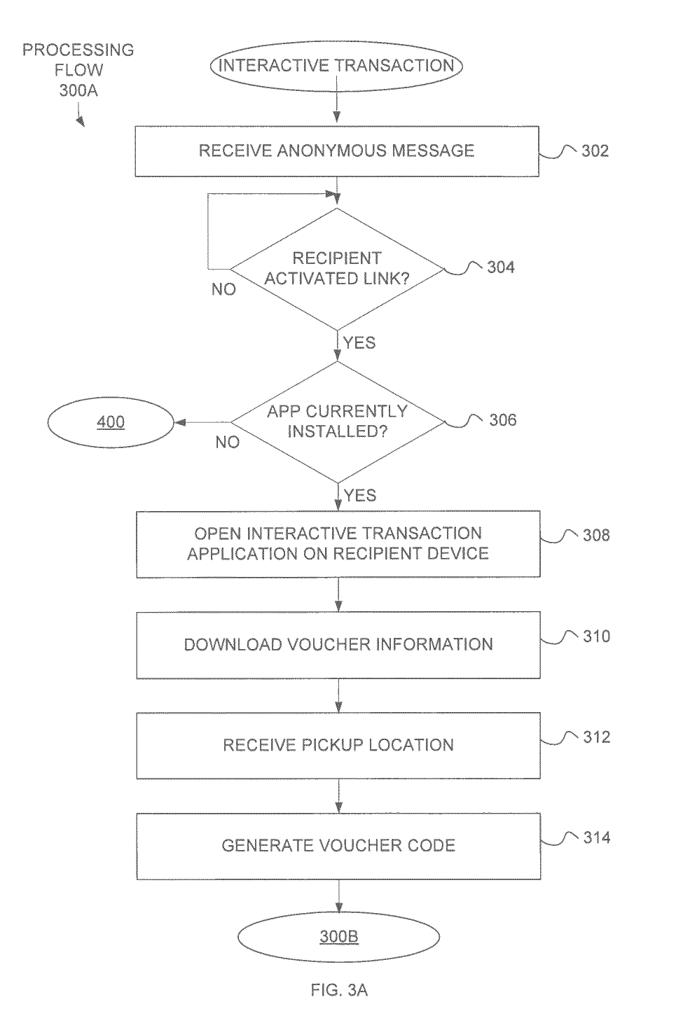

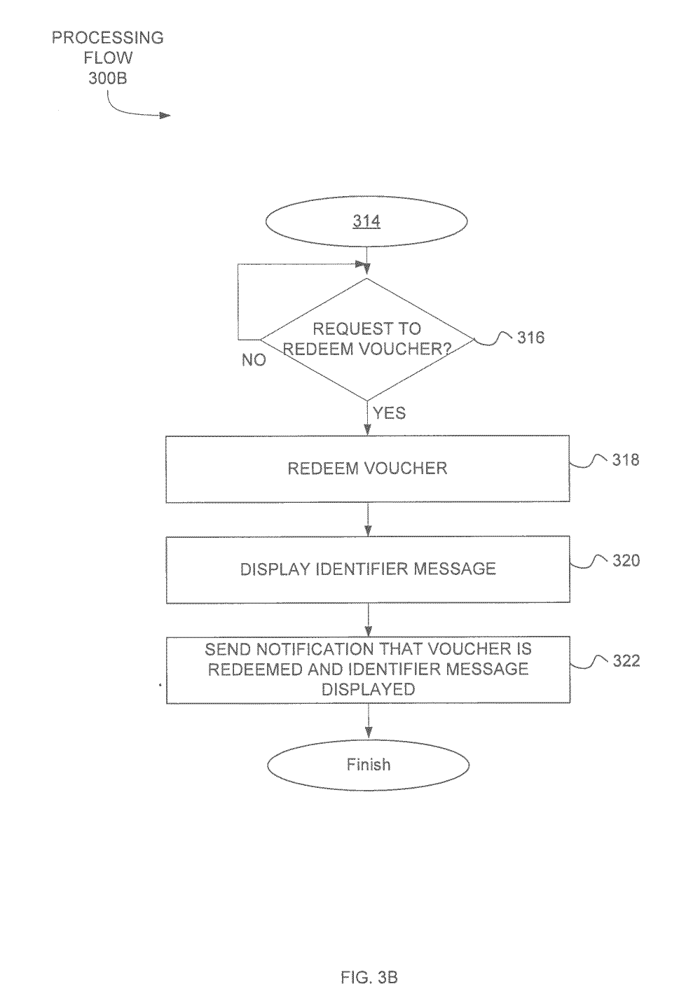

FIG. 3A is flow diagram illustrating a recipient-side interactive transaction processing flow, according to an implementation of the present disclosure. The processing flow method 300A may be performed by processing logic that comprises hardware (e.g., circuitry, dedicated logic, programmable logic, microcode, etc.), software (e.g., instructions run on a processing device to perform hardware simulation), or a combination thereof. In one embodiment, processing device 150 may perform method 300A. Method 300A may be performed in any order so as to fit the needs of the specific interactive transaction to be performed.

At block 302 of method 300A, processing logic receives an anonymous message. In one embodiment, the anonymous message containing a unique link to a voucher is received from interactive transaction unit 110. In another embodiment, the anonymous message is received directly from a benefactor's user device (e.g. user device 130). In one embodiment, the anonymous message is an SMS message. In another embodiment the anonymous message is an email. In one embodiment, processing logic at block 304 waits for the recipient to active the unique link send in the anonymous message. Once a recipient activates a unique link on his or her user device 132, flow continues to block 306.

At block 306, processing logic determines if an interactive transaction application associated with the unique link is currently installed on the recipient's user device 132. In one embodiment, an example of such an associated interactive transaction application is the LuvTap™ application. If the processing logic of method 300A determines that the application is not currently installed, processing flow continues to method 400. In another embodiment, if the processing logic of method 300A determines that the associated application is currently installed on user device 132, flow continues to block 308.

At block 308, in one embodiment processing logic on the recipient's user device 132 opens the interactive transaction application currently installed on the user device 132. At block 310 processing logic causes the application opened in block 308 to download voucher information. In one embodiment, voucher information is all the information necessary to facilitate the redemption of the voucher offline. This storing of voucher information on the recipient's user device 132 may be done so that a gift recipient need not rely on having cellular or data service at the time of redemption. In another embodiment, voucher information is not stored to the user device 132 and therefore redeeming a voucher when cellular or data service is inactive is not possible.

At block 312, processing logic receives a pickup location for the voucher. In one embodiment, after receiving a voucher, a recipient may choose where he or she would like to redeem the voucher. For example, if a recipient has been gifted a coffee, he or she will receive a “coffee” voucher. The recipient may then choose where he or she would like to redeem the coffee voucher—choosing between retailers listed on the interactive transaction application. When a recipient selects a location at which to redeem the voucher, processing logic at block 312 receives the selection. In another embodiment, the voucher is valid at any retailer location and therefore the recipient need not choose a location at which to redeem the voucher. In another embodiment, a voucher may be valid at several locations and a recipient need not choose a specific location at which to redeem the voucher before redemption.

In one embodiment, once processing logic receives the location at which the recipient would like to redeem his or her gift, processing logic at block 314 generates a voucher code for the gift that is specific to the location chosen by the recipient. In one embodiment, a voucher code is specific to the retailer that the recipient selects at block 312. In one embodiment, once a voucher code is generated at bock 314, the recipient may not select a different retailer from which to redeem the gift. In another embodiment, a recipient may go back and change a pickup location preference even after the voucher code is created. In such a scenario a new voucher code will need to be created and the old one deleted so as not to allow a recipient to redeem one voucher at more than one retailer. Once the voucher code is generated, flow continues to method 300B.

FIG. 3B is a flow diagram illustrating a recipient-side interactive transaction processing flow that continues from FIG. 3A, according to an implementation of the present disclosure. The processing flow method 300B may be performed by processing logic that includes hardware (e.g., circuitry, dedicated logic, programmable logic, microcode, etc.), software (e.g., instructions run on a processing device to perform hardware simulation), or a combination thereof. In one embodiment, processing device 150 may perform method 300B. Method 300B may be performed in any order so as to fit the needs of the specific interactive transaction to be performed.

At block 316 of method 300B, processing logic waits for the recipient to request to redeem the voucher code generated in block 314. Once the request has been received at block 316, flow continues to block 318 where processing logic marks the voucher as redeemed. In one embodiment, once a voucher is marked as redeemed, it may no longer be used in exchange for a gift. In one embodiment, the interactive transaction application maintains a list of all the recipient's vouchers—both active and redeemed. In another embodiment once a voucher is marked as redeemed a record of its existence is no longer kept on the recipient's user device 132.

In one embodiment, once a voucher has been redeemed, processing logic at block 320 may display an identifier message. In one embodiment an identifier message reveals the identity of the benefactor who sent the gift to the recipient. In one embodiment, the identifier message is stored on the recipient's user device 132. In one embodiment the identifier message is sent from a remote server and received by the processing logic of method 300B. One example of a remote server that may send the identifier message is server 102. In one embodiment, the processing logic of method 300B only displays the identifier message when the recipient redeems the voucher received in block 210. In another embodiment, the identifier message may be displayed on the recipient's user device 132 at the expiration of the expiration timer, regardless of whether the recipient has redeemed the voucher. In other embodiments, processing logic may display the identifier message when other conditions are met. For example, the identifier message may be sent to a recipient when he or she walks into the retailer where the gift is about to be redeemed. In other embodiments a recipient may be able to pay or donate money to a charity in order to have the identifier message released.

In one embodiment interactive transaction unit 110 may send the identifier message that is received and displayed by processing logic at block 320. In this example, the identifier message may be displayed by processing logic in the interactive transaction application, as an SMS message, an email, a push notification, or by any other means capable of displaying a message on a user device 132.

In one embodiment, the processing logic of method 300B may send a notification to the benefactor's user device 130 that the voucher has been redeemed and the identifier message displayed at block 322. In one embodiment, the notification is sent via interactive transaction unit 110. The notification may take any form capable of relaying the message to the benefactor.

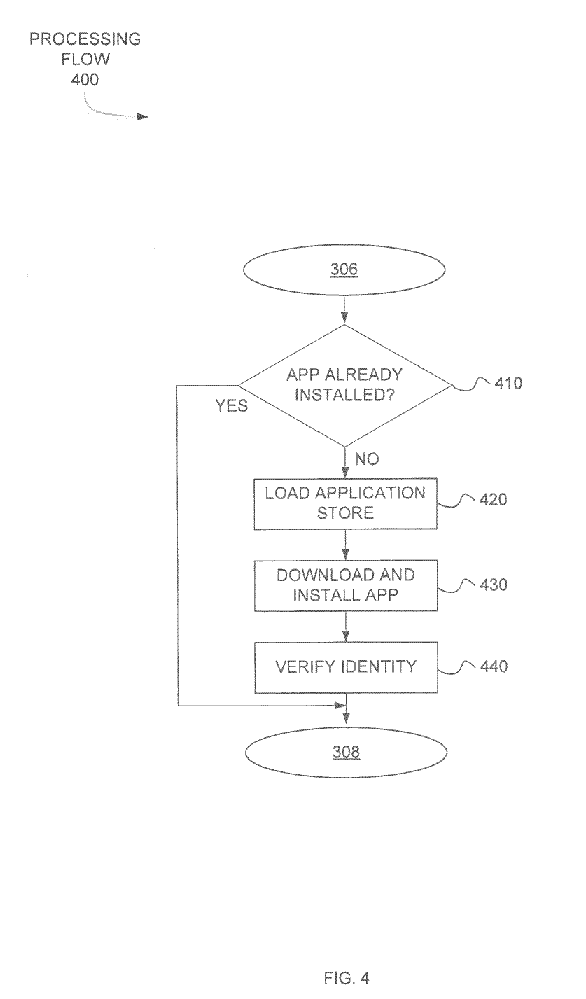

FIG. 4 is a flow diagram illustrating an interactive transaction application download processing flow, according to an implementation of the present disclosure. Method 400 continues from block 306 of method 300A. The processing flow method 400 may be performed by processing logic that comprises hardware (e.g., circuitry, dedicated logic, programmable logic, microcode, etc.), software (e.g., instructions run on a processing device to perform hardware simulation), or a combination thereof. In one embodiment, processing device 150 may perform method 400. Method 400 may be performed in any order so as to fit the needs of the specific interactive transaction to be performed.

Continuing from block 306 of method 300A where it was determined that an interactive transaction application associated with a voucher unique link is not currently installed on a recipient's user device 132, processing logic at block 410 causes the application store on the recipient's user device 132 to load. In one embodiment, examples of application stores are Apple's App Store™ and Android's Google Play Store™. Alternatively, other application stores may be used. In one embodiment, processing logic causes the application store to display the interactive transaction application associated with the unique link. This may be performed so that the recipient need not manually search for the interactive transaction application from within the application store.

At block 420 processing logic causes the interactive transaction application to be downloaded and installed on the recipient's user device 132. In one embodiment, this occurs after the user initiated the download and consents to the installation of the application. In another embodiment, the application is downloaded and installed automatically.

At block 430 the identity of the recipient is verified by processing logic. In one embodiment, the recipient's identity may be verified with a phone number. In another embodiment the recipient's identity may be verified by requiring the user to enter a verification code sent to the phone number of the intended recipient. In other embodiments other methods of identity verification may be used. In another embodiment verification is not required. Once complete, processing logic causes flow to continue to block 306 of method 300A.

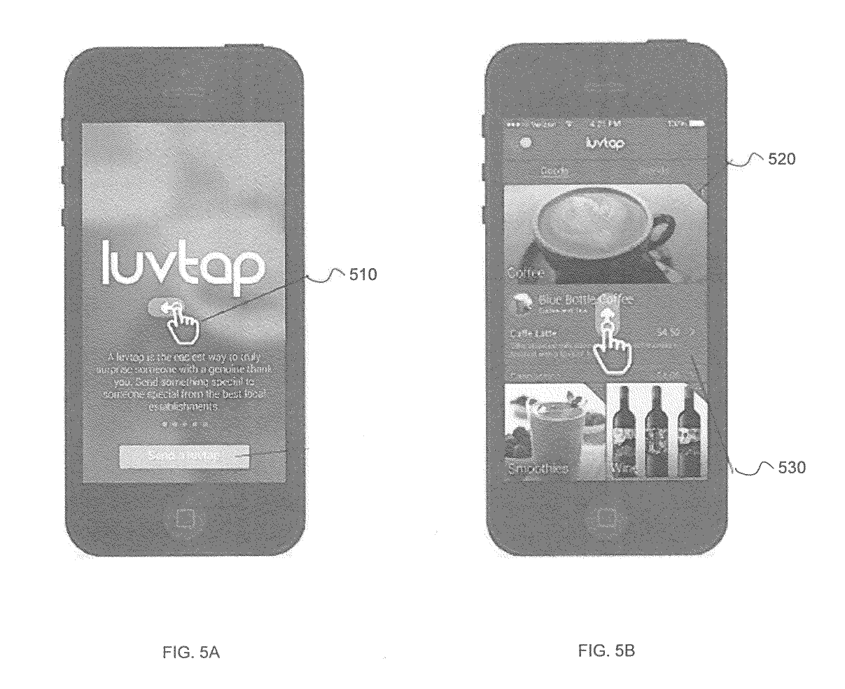

FIG. 5A is a block diagram illustrating a tutorial screen of an interactive transaction application, according to an implementation. In one embodiment, a benefactor or recipient may choose to walk through a tutorial that explains how to use the interactive transactional application. A user may swipe 510 the screen to navigate through the various screens of the tutorial.

FIG. 5B is a block diagram illustrating a gift detail screen of an interactive transaction application, according to an implementation. In one embodiment, the interactive transaction application may show a user a detailed view of a gift available for purchase. The detailed view may display an image of the gift 520 and gift details 530. In one embodiment, a user may be able to swipe down on the gift details to reveal additional details. Gift details may include, for example, one or more of price, location, and description of the gift. In other embodiments, gift details may include other information associated with the gift.

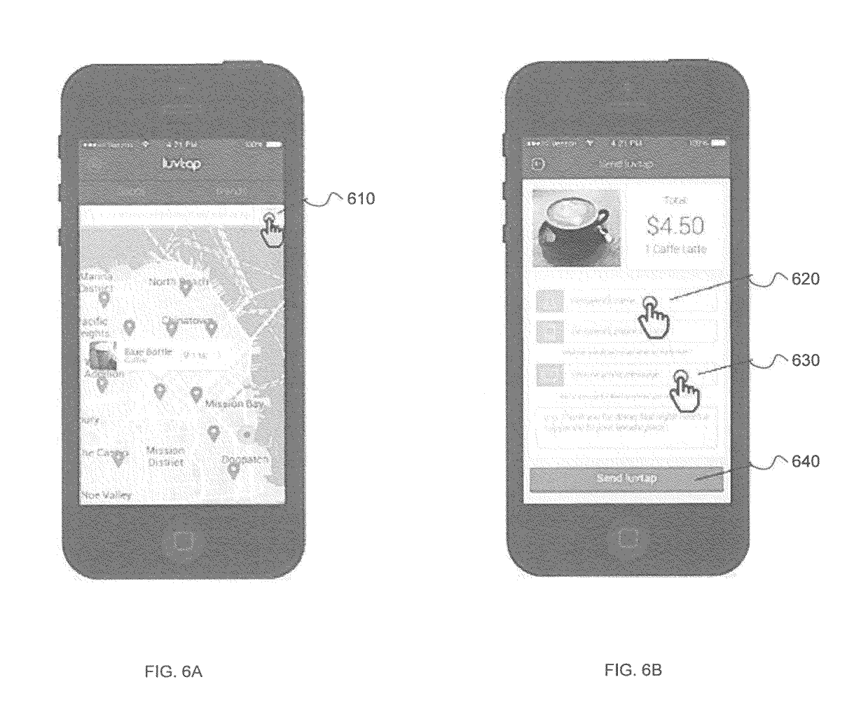

FIG. 6A is a block diagram illustrating a location view screen of an interactive transaction application, according to an implementation. In one embodiment, a benefactor may choose to show available gifts on a map view. In one embodiment, the benefactor may search for a location with an address, city name, or zip code. In another embodiment, the benefactor may be able to lookup contact information for contacts stored on the user device 130. Additionally, a benefactor may be able to switch to a list view of the gifts by clicking on a dedicated list view icon 610. In another embodiment, benefactor may be presented with a filer view that enables the filtering of the map display. Filtering may include, for example, one or more of filtering by category, retailer, and location. In other embodiments, filtering may include other variables related to interactive transactions.

FIG. 6B is a block diagram illustrating a send gift screen of an interactive transaction application, according to an implementation. In one embodiment, a benefactor may be presented with various options while on a “send gift” screen of the interactive transaction application. Here, a benefactor may fill out contact information for the recipient 620, choose a hint message 630, and send the gift 640.

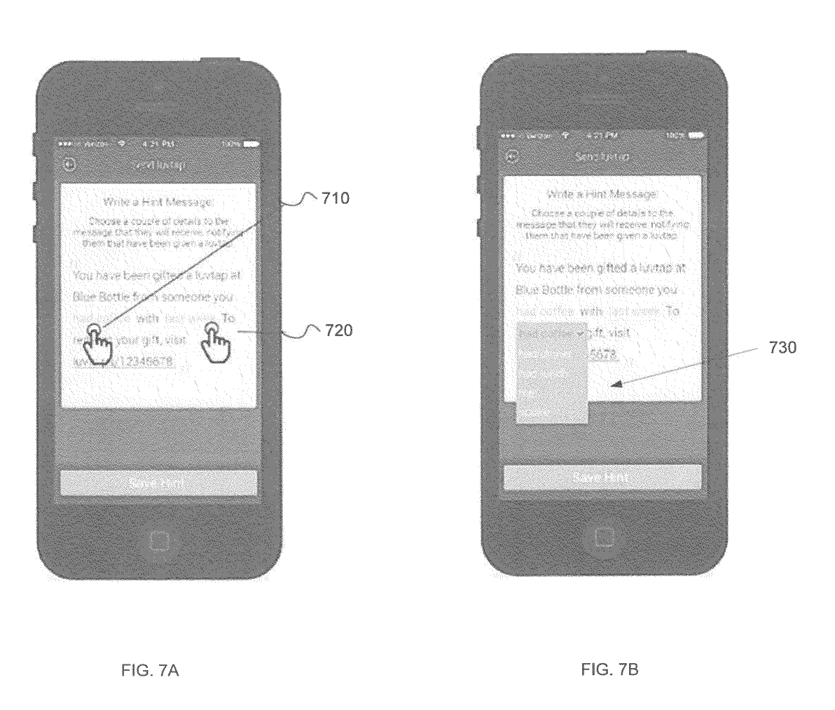

FIG. 7A is a block diagram illustrating a hint message screen of an interactive transaction application, according to an implementation. In one embodiment, a benefactor may choose to send a hint message with the gift voucher. In one implementation, the interactive transaction application may present wording options 710, 720 for the hint message in order to help the benefactor compose the message.

FIG. 7B is a block diagram illustrating a hint message dropdown screen of an interactive transaction application, according to an implementation. In one implementation, clicking on words 730 within the hint view of the interactive transaction application reveals to the benefactor various wording options for the hint message. In another embodiment, a user may compose a hint message without the help of wording options.

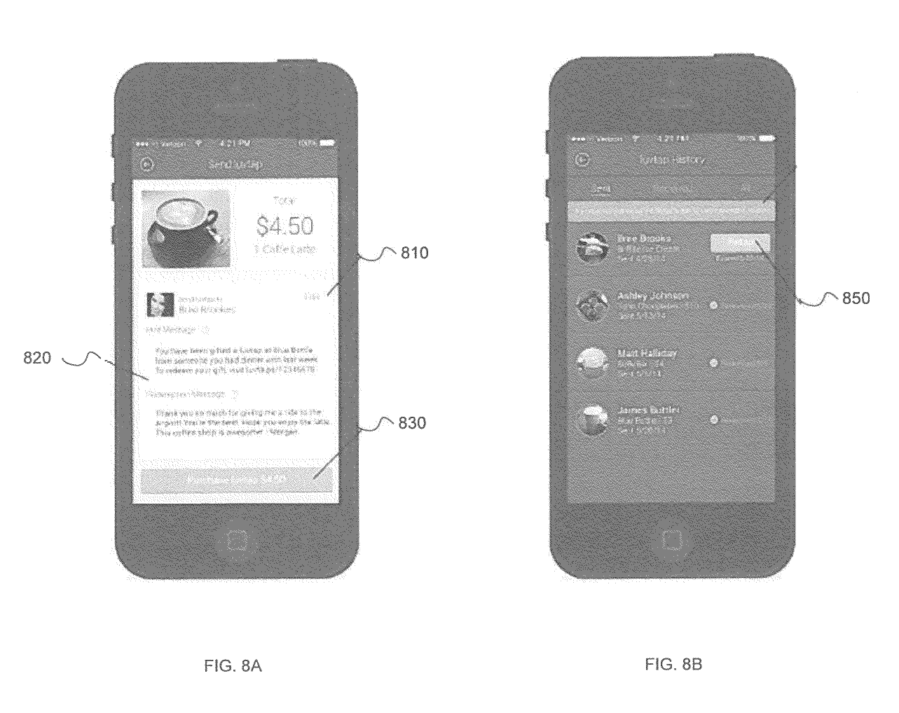

FIG. 8A is a block diagram illustrating a send gift screen of an interactive transaction application, according to an implementation. In one embodiment, a benefactor has the option to edit 810 the details of the gift from this screen. A benefactor may also be able to view 820 both a compose hint message and an identifier message before finalizing the transaction 830. In one embodiment, a benefactor will be able to determine when he would like the message to be sent. In one embodiment, the send gift screen will enable a benefactor to choose to send the message immediately. In another embodiment, the benefactor may choose to have the message sent at a later time of his choosing and change the appropriate settings on the send gift screen. In another embodiment, the benefactor will be able to set the timing details of the message delivery from a screen other than the send gift screen.

FIG. 8B is a block diagram illustrating a gift history screen of an interactive transaction application, according to an implementation. In one implementation, a user can view the status of sent and received gifts. In one embodiment, a benefactor is able to view expired gifts, and resend an expired gift by clicking a button on the touchscreen.

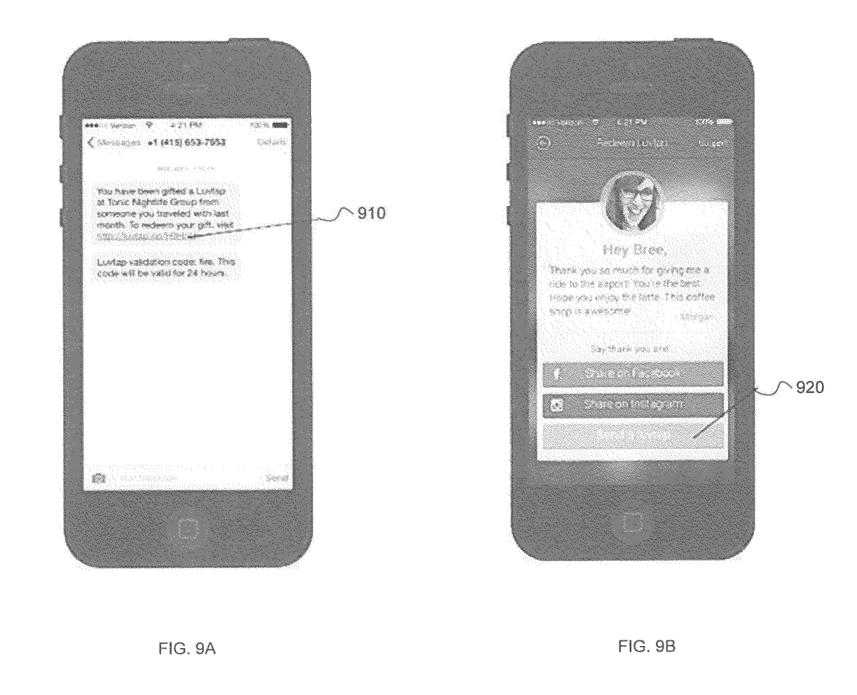

FIG. 9A is a block diagram illustrating an anonymous message, according to an implementation. In one embodiment, the anonymous message is a text message. In another embodiment, the anonymous message may be any other sort of message. In one embodiment, the anonymous message includes a unique link 910 to a gift voucher.

FIG. 9B is a block diagram illustrating an identifier message, according to an implementation. In one embodiment, the identifier message is displayed after a recipient redeems a gift voucher. In one embodiment, the recipient is also presented with various other options, including sending a gift 920 to someone else.

FIG. 10 illustrates a diagrammatic representation of a server 102 in the example form of a computing device within which a set of instructions, for causing the machine to perform any one or more of the methodologies discussed herein, may be executed. The server 102 may be in the form of a computing device (e.g., a server computer) within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example server 102 includes a processing device 1002, a main memory 1004 (e.g., read-only memory (ROM), flash memory, dynamic random access memory (DRAM) such as synchronous DRAM (SDRAM)), a static memory 1006 (e.g., flash memory, static random access memory (SRAM)) and a data storage device 1018, which communicate with each other via a bus 1030.

Processing device 1002 represents one or more general-purpose processing devices such as a microprocessor, central processing unit, or the like. More particularly, the processing device 1002 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1002 may also be one or more special-purpose processing devices such as an application specific integrated circuit (ASIC), a field programmable gate array (FPGA), a digital signal processor (DSP), network processor, or the like. The processing device 1002 is configured to execute interactive transaction logic 1019 for performing the operations and steps discussed herein.

The server 102 may further include a network interface device 1008 which may communicate with a network 1020. The server 102 also may include a video display unit 1010 (e.g., a liquid crystal display (LCD) or a cathode ray tube (CRT)), an alphanumeric input device 1012 (e.g., a keyboard), a cursor control device 1014 (e.g., a mouse) and a signal generation device 1016 (e.g., a speaker). In one embodiment, the video display unit 1010, the alphanumeric input device 1012, and the cursor control device 1014 may be combined into a single component or device (e.g., an LCD touch screen).

In one embodiment, data storage device 1018 may represent storage device 120. The data storage device 1018 may include a computer-readable medium 1028 on which is stored one or more sets of instructions (e.g., instructions of module 1022, such as an interactive transaction module) embodying any one or more of the methodologies or functions described herein. The module 1022 may (e.g., an interactive transaction module) also reside, completely or at least partially, within the main memory 1004 and/or within the processing device 1002 during execution thereof by the server 102, the main memory 1004 and the processing device 1002 also constituting computer-readable media. The instructions may further be transmitted or received over a network 1020 via the network interface device 1008.

While the computer-readable storage medium 1028 is shown in an example embodiment to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media and magnetic media.

In the above description, numerous details are set forth. It will be apparent, however, to one of ordinary skill in the art having the benefit of this disclosure, that embodiments of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “sending,” “opening,” “generating,” “redeeming,” “displaying,” “storing,” “starting.” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a non-transitory computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

The above description sets forth numerous specific details such as examples of specific systems, components, methods and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth above are merely examples. Particular implementations may vary from these example details and still be contemplated to be within the scope of the present disclosure.

It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
receiving from a first user device, by a processing device of a computer system, a gift from a plurality of gifts;
receiving from the first user device, an identifier message to be directed to a second user device;
sending, to the second user device, an anonymous message comprising a unique link to a voucher;
releasing, by the processing device, the identifier message to the second user device upon execution of an act on the second user device.

2. The method of claim 1, further comprising: sending a hint message to the second user device.

3. The method of claim 1, wherein the gift selection and the identifier message are received from a software application.

4. The method of claim 1, wherein the message alerting the beneficiary that the gift has been received is a text message.

5. The method of claim 1, wherein the message alerting the beneficiary that the gift has been received is an email message.

6. The method of claim 1, wherein the act by the beneficiary is the act of redeeming the gift.

7. A method comprising:
receiving, by a processing device of a server, a selected voucher from a plurality of vouchers, recipient information, an identifier message, and payment information from a first user device;
sending, to a second user device, an anonymous message containing a unique link to the voucher;
receiving a first notification that the second user device activated the unique link to the voucher;
sending a verification code to the second user device after receiving the first notification that the second user device activated the unique link to the voucher;
sending the identifier message to the second user device; and
receiving a second notification that the second user device redeemed the voucher.

8. The method of claim 7, wherein sending the anonymous message containing a unique link to the voucher comprises:
receiving a phone number of the recipient;
sending the phone number of the recipient to a Short Message Service (SMS) gateway; and
receiving, by a processing device of the server, a third notification that an anonymous text message containing a unique link to the voucher has been sent by the SMS gateway to the recipient.

9. The method of claim 8, further comprising:
receiving a hint message from the first user device;
sending the hint message to the SMS gateway; and
receiving a third notification that the hint message has been sent by the SMS gateway to the second user device.

10. The method of claim 7, wherein voucher information is associated with the unique link to the voucher.

11. The method of claim 7, further comprising: starting an expiration timer after the second user device requests to activate the voucher.

12. The method of claim 7, further comprising: receiving a third notification that the identifier message has been received.

13. The method of claim 7, wherein sending the anonymous message containing the unique link to the voucher is an anonymous email message.

14. A method comprising:
receiving, by a processing device on a user device, an anonymous message containing a unique link associated with a voucher;
opening an interactive transaction application associated with the unique link on the user device after receiving a first notification that the first user device activated the unique link;
downloading, from a remote server, voucher information associated with the unique link;
receiving, from the user device, a pickup location for an item associated with the voucher;
generating a voucher code for the item associated with the pickup location;
redeeming the voucher code after receiving a request from the user device to redeem the voucher code;
displaying, by the processing device on the user device, an identifier message on the user device; and
sending a second notification, to the remote server, that the voucher has been redeemed and the identifier message has been displayed.

15. The method of claim 14, wherein the anonymous message is an anonymous Short Message Service (SMS) message.

16. The method of claim 14, further comprising: determining, after receiving the first notification that the user device activated the unique link, that an interactive transaction application associated with the unique link is installed on the user device.

17. The method of claim 14, further comprising:
determining that the interactive transaction application associated with the unique link is not installed on the user device;
causing an application store to load on the user device;
causing the application store to download and install the interactive transaction application associated with the unique link to the user device; and
causing the interactive transaction application to verify the phone number of the user device.

18. The method of claim 15, wherein the SMS message further comprises a hint message.

19. The method of claim 14, further comprising: storing the voucher information associated with the unique link locally on the user device.

20. The method of claim 14, wherein the anonymous message is an anonymous email message.
